(19) United States
(12) Patent Application Publication
(10) Pub. No.: US 2005/0208893 A1
(43) Pub. Date: Sep. 22, 2005

(54) Bluetooth earphone module with audio player function

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/801,710

(22) Filed: Mar. 17, 2004

(51) Int. Cl. H04Q 7/20

(52) U.S. Cl. 455/41.2

(57) ABSTRACT

A bluetooth earphone module with audio player function has a DSP unit for processing the digital signal, a bluetooth module receiving a remote data signal and replying with a modulation signal, a voice transmission and encoder/decoder unit connected to the DSP unit and the bluetooth module for encoding/decoding voice and converting digital/analog messages, an audio player decoder connected to the DSP unit for decoding the audio player file to the voice signal, a voice output unit connected to the voice transmission and encoder/decoder unit and the audio player decoder.

### BACKGROUND OF THE INVENTION

1. Field of the Invention

The present invention relates to a bluetooth earphone module with audio player function, more specially, relates a bluetooth earphone module that plays audio player music.

2. Description of the Related Art

The bluetooth technology is a low-cost, low-power and short-distance wireless communications technology, and can be widely applied by any personal mobile communications equipment. Making use of the function of wireless transmission, bluetooth wireless earphones, portable mobile phone watches, and communication devices that are directly worn on a finger can be designed. These products not only accomplish wireless transmission but also provide Internet access and e-mail.

There are various commercially available bluetooth earphones. They generally work with bluetooth mobile phones. Through bluetooth communications technology, incoming voice messages of a bluetooth mobile phone can be wirelessly transmitted to a bluetooth wireless earphone, and voice messages to be transferred can also be wirelessly transmitted to the bluetooth mobile phone via the bluetooth wireless earphone, thereby accomplishing full-duplex communications.

MP3 (MPEG Audio Layer3) is a low-distortion data compression technique. This technique uses a special data compression algorithm to process audio signals. The digital audio document size after audio player compression is one tenth the original data size, while the quality of the audio signal is almost the same as CD audio quality. Thus, the MP3 audio player is the most popular audio player today.

Because the bluetooth earphone can be miniaturized and carried conveniently, the present invention combines the audio player decoder with the bluetooth earphone module to form one bluetooth earphone module with audio player function. Moreover, the bluetooth earphone can connect to a memory card to expand the memory storage thereof.

### SUMMARY OF THE INVENTION

The primary object of the present invention is to install an audio player decoder and a memory unit in the bluetooth earphone for forming the bluetooth earphone module with audio player function.

For the primary object above, the present invention comprises a DSP unit processing the digital signal, a bluetooth module receiving a remote data signal and replying with a modulation signal, a voice transmission and encoder/decoder unit connected to the DSP unit and the bluetooth module for encoding and decoding the voice and converting digital data and analog data, and the voice transmission and encoder/decoder unit connected to a voice output unit and a microphone, thereby accomplishing full-duplex communications.

Furthermore, an audio player decoder is connected to the DSP unit for decoding the audio player file into a voice signal. The voice signal is transmitted outside and played by the audio player via the voice output unit.

### BRIEF DESCRIPTION OF THE DRAWINGS

The various objects and advantages of the present invention will be more readily understood from the following detailed description when read in conjunction with the appended drawing, in which:

FIG. 1 shows a perspective drawing of the present invention with a memory card installed;

FIG. 2 shows a perspective drawing according to the present invention with an ancillary earphone connected thereto;

FIG. 3 shows a circuit block diagram of the present invention; and

FIG. 4 shows a circuit block diagram of the present invention connected with an ancillary earphone connected thereto.

### DETAILED DESCRIPTION OF PREFERRED EMBODIMENTS

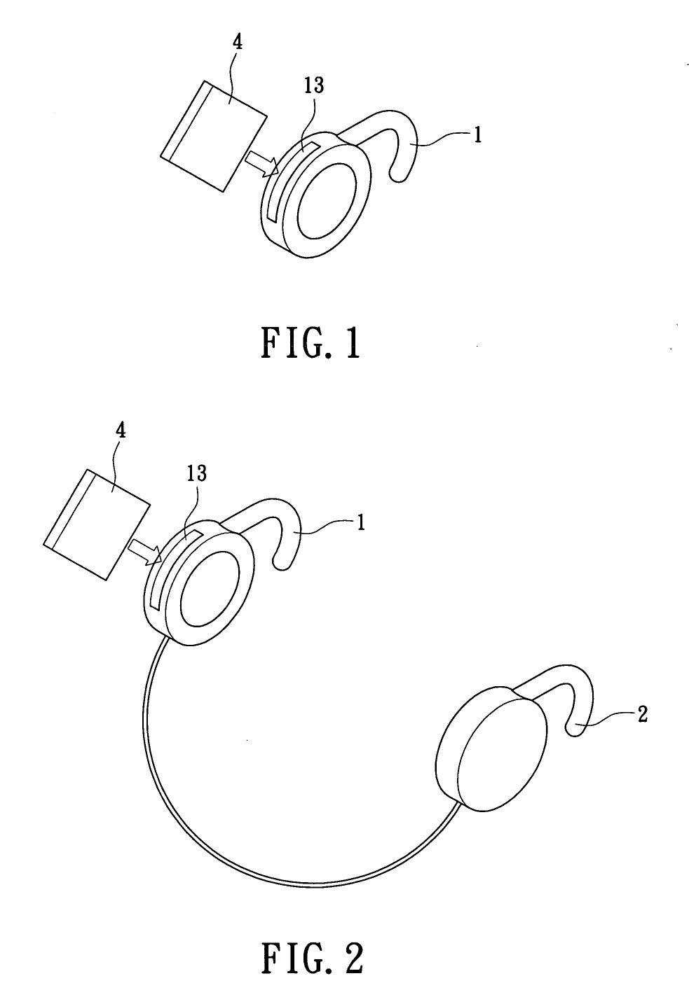

FIG. 1 shows a perspective drawing of the present invention installed with a memory card. The bluetooth earphone module 1 with audio player function of the present invention comprises a memory socket for accommodating a memory card 4. The memory card 4 is removably installed in the bluetooth earphone module 1 for expanding the storage capacity of the bluetooth earphone module 1 with audio player function according to the present invention.

FIG. 2 shows a perspective drawing according to the present invention connected to an accessory such as, for example, an ancillary earphone. The bluetooth earphone module 1 is connected to the ancillary earphone for achieving stereophonic voice.

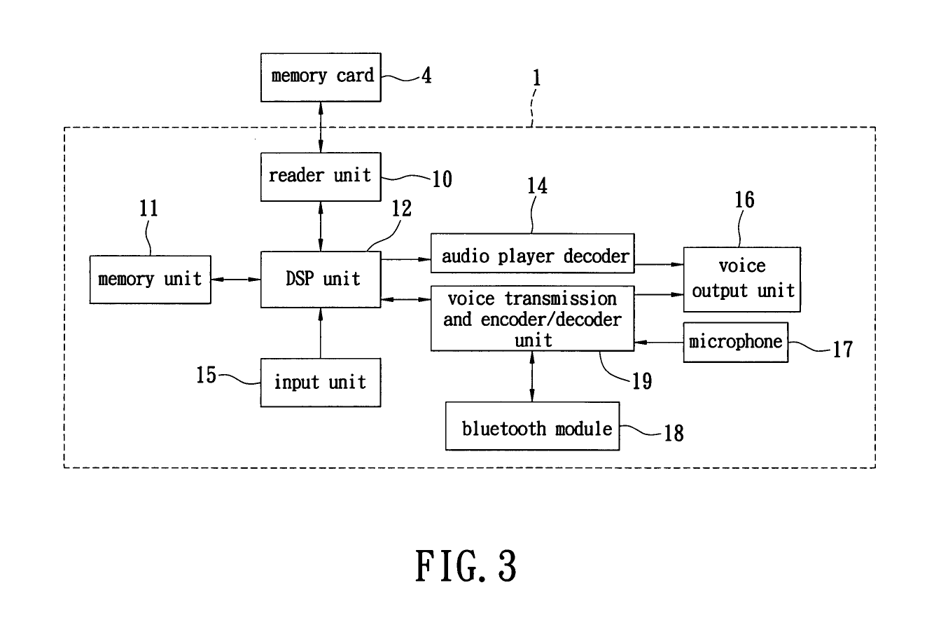

FIG. 3 shows a circuit block diagram of the present invention. The bluetooth earphone module 1 is connected to a memory card 4 for expanding the memory storage, which comprises a DSP unit 12, an audio player decoder 14, a voice transmission and encoder/decoder unit 19, a voice output unit 16, a bluetooth module 18, a microphone 17, a memory unit 11, a reader unit 10 and an input unit 15.

As shown in FIG. 3, the memory unit 11 is connected to the DSP unit 12, and controlled by the DSP unit 12 for accessing the digital data. In the above-mentioned embodiment, the memory unit 11 is a flash memory. Moreover the DSP unit 12 is connected to the reader unit 10 for accessing the digital data of the memory card 4 through the reader unit 10. The present invention expands the memory storage with the removable memory card 4. The memory card 4 is a flash memory, which stores a large number of audio player digital files, and is removably connected to the reader unit. In the above-mentioned description, the memory card 4 is, for example, an MS (Memory Stick) card, a CF (Compact Flash) card, an SMC (Smart Media) card, an MMC (Multi Media) card or an SD (Secure Digital) card.

As shown in FIG. 3, the DSP unit 12 is connected to the audio player decoder unit 14 and the input unit 15, and the input unit 15 controls the DSP unit 12 with a control signal for achieving communication between a user and a machine.

Furthermore, the DSP unit 12 controls the audio player decoder unit 14 to decode the audio player digital file in the memory unit 11 into a voice signal. The voice output unit 16 is connected to the audio player decoder unit 14 for receiving the voice signal and outputting the audio player music to a user. As mentioned above, the audio player decoder unit 14 is controlled by the input unit 15 to control the reader unit 10 to access the audio player digital file in the memory card 4. Similarly, audio player decoder unit 14 decodes the audio player digital file in the memory card 4 into a voice signal, and transmits the voice signal to the voice output unit 16 to output the audio player music to a user. Moreover, the output unit 16 is an earphone. As shown in FIG. 3, the voice transmission and encoder/decoder unit 19 is connected to the DSP unit 12 and the bluetooth module 18 for processing the encoding/decoding voice and converting digital/analog messages. The bluetooth module 18 is used to receive a remote data signal and reply with a modulation signal. The remote data signal is an incoming call signal. The voice transmission and encoder/decoder unit 19 decodes the remote data signal and transmits to the DSP unit 12. After processing the voice signal, the DSP unit 12 transmits the voice signal to the voice output unit 16, which is connected to the voice transmission and encoder/decoder unit 19.

At the same time, the microphone 17 is connected to the voice transmission and encoder/decoder unit 19 and transmits the voice signal to the voice transmission and encoder/decoder unit 19. The DSP unit 12 controls the voice transmission and encoder/decoder unit 19 to encode the voice signal, and controls the bluetooth module 18 to reply with the modulation signal to a remote bluetooth cell phone.

When receiving a phone call, the bluetooth module 18 will receive the remote data signal and then pass it to the voice transmission, the encoder/decoder unit 19 and the DSP unit 12 for processing. After processing by the DSP unit 12, the voice transmission and encoder/decoder unit 19 transmits a voice signal to the voice output unit 16 to people for listening. At this time, if the user is listening to an audio player music file via the voice output unit 16, the DSP unit 12 will interrupt the playing of the audio player file in advance and then the user can hear the telephone voice message via the voice output unit 16. When the call is terminated, the DSP 12 continues playing the audio player file.

Meanwhile, when the user speaks, his or her voice signal will be sent via the microphone 17 to the voice transmission and encoder/decoder unit 19. After processing by the voice transmission and encoder/decoder unit 19, the voice signal will be passed to the bluetooth module 18. Then, the bluetooth module 18 will reply with a modulation signal to the remote bluetooth cell phone. By this way, full-duplex voice communication can be obtained.

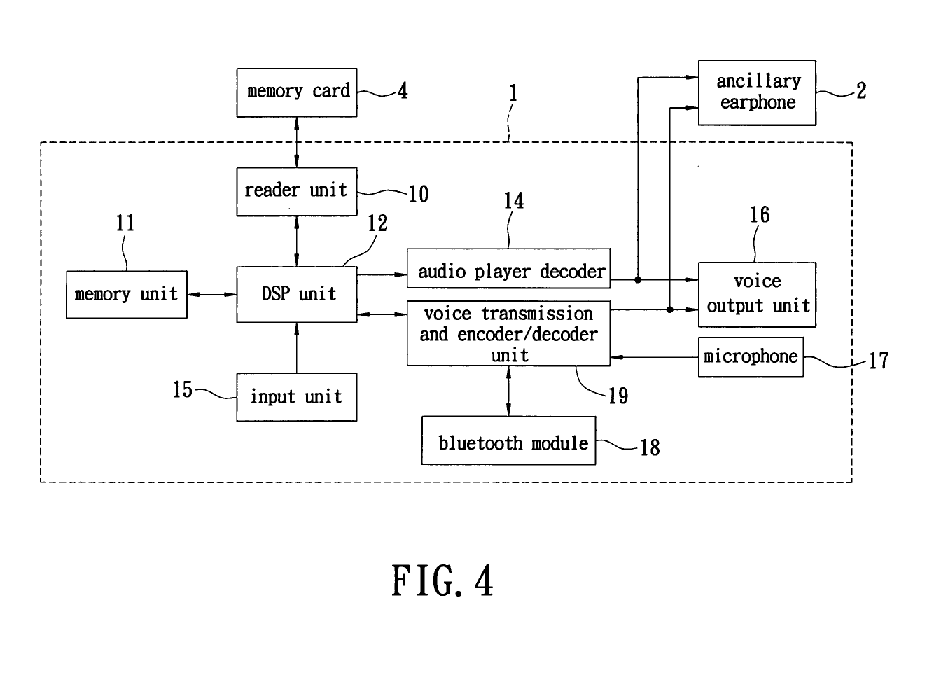

With reference also to FIG. 3, FIG. 4 shows a circuit block diagram of the present invention connected the accessory earphone. FIG. 4 is different from FIG. 3 with regard to the ancillary earphone 2. The ancillary earphone 2 is connected to the audio player decoder 14, the voice transmission and encoder/decoder 19 and the voice output unit 16 for achieving the stereophonic voice by cooperating with the voice output unit 16. The other elements in FIG. 4 have functions similar to those shown in FIG. 3.

As mentioned above, the present invention can be used to perform wireless connection with the remote bluetooth cell phone via the bluetooth module 18 so as to obtain full-duplex voice communication with the remote bluetooth cell phone.

Furthermore, the present invention can use the DSP unit 12 to control the audio player decoder 14 to decode the audio player digital file into the voice signal, and the audio player digital file stored in the memory unit 11. Moreover, the present invention can use the DSP unit 12 to control the reader unit 10 to access the audio player digital file in the memory card 4, and control the audio player decoder 14 to decode the audio player digital file into the voice signal. In the above-mentioned description, the audio player decoder 14 transmits the voice signal to the voice output unit 16 to a user.

Moreover, the present invention can be connected to an ancillary earphone for achieving the stereophonic voice.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A bluetooth earphone module with audio player function, comprising:
a DSP unit processing a digital signal;
a bluetooth module receiving a remote data signal and replying with a modulation signal;
a voice transmission and encoder/decoder unit connected to the DSP unit and the bluetooth module for encoding/decoding voice and converting digital/analog messages;
an audio player decoder connected to the DSP unit for decoding the audio player file into a voice signal;
a voice output unit connected to the voice transmission and encoder/decoder unit and the audio player decoder; and
a microphone connected to the voice transmission and encoder/decoder unit.

2. The bluetooth earphone module of claim 1, wherein a memory unit is connected to the DSP unit for storing the digital data.

3. The bluetooth earphone module of claim 2, wherein the memory unit is a flash memory.

4. The bluetooth earphone module of claim 1, wherein an input unit is connected to the DSP unit for controlling the DSP unit with a control signal.

5. The bluetooth earphone module of claim 1, wherein the voice output unit is an earphone.

6. The bluetooth earphone module of claim 1, further comprising an ancillary earphone connected to the voice transmission and encoder/decoder and the audio player decoder.

7. The bluetooth earphone module of claim 1, further comprising a reader unit connected to the DSP unit and a memory card, and controlled by the DSP unit for accessing the digital data of the memory card.

8. The bluetooth earphone module of claim 7, wherein the memory card is removably connected to the reader unit.

9. The bluetooth earphone module of claim 7, wherein the memory card is a flash memory.

10. The bluetooth earphone module of claim 7, wherein the memory card is an MS (Memory Stick) card, a CF (Compact Flash) card, an SMC (Smart Media) card, an MMC (Multi Media) card or an SD (Secure Digital) card.
